(19) United States
(12) Patent Application Publication
(10) Pub. No.: US 2024/0032524 A1
(43) Pub. Date: Feb. 1, 2024

(54) Electric Grid for Killing Insects

(71) Applicant: Cass Kurzinski, Cary, IL (US)

(72) Inventor: Cass Kurzinski, Cary, IL (US)

(21) Appl. No.: 17/876,770

(22) Filed: Jul. 29, 2022

(51) Int. Cl. A01M 1/22

(52) U.S. Cl. CPC A01M 1/223

(57) ABSTRACT

A copper grid which is attached to a rigid, non-conductive substrate, and configured to be connected to a voltage source such that the grid is electrified for the purpose of controlling insect populations.

### FIELD OF THE INVENTION

The present invention relates to insect control devices. More specifically, the present invention relates to insect control devices which kill insects via contact with an electrified grid.

### BACKGROUND OF THE INVENTION

Insect killing devices which utilize electric means to electrocute, and thereby kill, nuisance insects are well known and in widespread applications (also known as bug zappers due to the sounds emitted as the insect is electrocuted). The devices utilize various techniques for attracting insects like led lighting, uv lighting, pheromones, and sounds. The voltages applied to the killing grids vary considerably, usually depending upon the target infestation. Smaller bodied insects, like mosquitoes, filth flies, and gnats for example, succumb at lower voltages (typically 450 v-800 v) and larger bodied insects, like moths, horse flies, and beetles for example, require larger voltages (typically 1000 v-6000 v) to eliminate the insect. The killing grid consists of wires which conduct an electrical charge and when the insect contacts the wires it causes a short circuit and allows the electrical current to pass through the insect body and electrocutes the pest.

Since the wires employed to convey the electrical charge are usually outdoors and exposed to the elements, and impacts from the insects, the grid materials suitable for the application are typically steel, stainless steel, nickel and aluminum alloys. Due to the fact that these materials are also resistant to electrical current the voltage is reduced and the wire will heat. In addition, since the grid wires are free standing, and must span a gap, the wires must be considerably thicker than is desirable from a cost and assembly standpoint. Due to the electrical resistance of these materials the total voltage allowable in the grid must be reduced to prevent the possibility of the wires overheating and causing fires. To overcome these limitations, grid designers are required to provide current interrupters to reduce or stop the current flow altogether during times when the grid material may in fact heat to an unacceptable level.

### SUMMARY OF THE INVENTION

A specially designed grid utilizing very thin copper tines, in a grid pattern, with alternating positive and negative charges that is adhered to a plastic substrate allows for the design of an improved electric insect killing device. Since the copper grid has a very low resistance to electrical current flow the voltage and amperage of the grid is easily controlled and can be much higher than is the case with existing designs. Since the copper material is very thin and flexible, it permits grid designers considerable opportunities to change the design from a flat surface to a cylindrical configuration or to any other shape to conform to the required application.

### BRIEF DESCRIPTION OF THE DRAWINGS

In the following drawings, which form a part of the specification, and which are to be construed in conjunction therewith, and in which like reference numerals have been employed throughout wherever possible to indicate like parts in the various views:

FIG. 1 is a top plan view of the electric grid;

FIG. 2 is a top isometric of substrate and copper tines of the electric grid;

FIG. 3 is a top plan view of the substrate and copper tines of the electric grid; and

FIG. 4 is a bottom view of the substrate.

### DESCRIPTION OF THE PREFERRED EMBODIMENTS

Through laboratory testing and following extensive field trials the applicant has discovered that by controlling the copper tine material and the thickness and width and the inter-grid spacing of the copper tines within the grid configuration it is possible to design an electrically powered killing grid 1 that is effective for eliminating nuisance insects.

The grid 1 is designed to be connected to a voltage source 2 and comprises copper tines 3 and a rigid substrate 4. Since the copper tines 3 that are required to effectively operate the system are very thin the preferred method to produce them is by photo chemical etching. Any other fabrication method results in tine edge warping, tine fracture, and other unacceptable flaws. In addition, by utilizing a thin copper sheet, which is very flexible, the grid itself can be affixed to a flat surface, a cylindrical surface, or configured to conform to virtually any shape that is required by the potential application.

The spacing between the individual tines 3 was also found to be a critical consideration for the successful system operation. If the tines 3 are too close together, a short circuit between adjacent tines may occur during rain or fog events. If the tines are too far apart, the insect will not contact the positive and negative tines simultaneously and subsequently will not be electrocuted. The preferred spacing range between adjacent tines 3 is 0.070 inches to 0.620 inches.

Due to materials cost considerations and workability, acrylic is indicated as the preferred substrate 4 material. Although acrylic is identified as the preferred grid substrate 4, it is understood that other rigid, non-conductive materials can be substituted for the acrylic substrate such as styrene-based plastics or tempered glass.

Since both the substrate 4 surface and the copper surface are smooth, the adhesive to be employed to affix the copper tines 3 to the substrate 4 also required considerable investigation and experimentation. Ultimately a synthetic elastomeric compound with 20% to 30% solids composition was determined to be the most suitable adhesive. This solids composition range requirement allows for the adhesive to expand and contract sufficiently while maintaining uniform contact with both the copper tine and the substrate during the expansion and contraction phenomenon. Since the elastomer-based adhesives contain significant volatile organic compounds (VOCs), which under certain conditions could be a health hazard to the applicator, further field trials were undertaken to identify additional substitute adhesive compounds or application methodologies. From these field trials, it was determined that a double-sided tape with an acrylic-based adhesive was effective at securing the copper tines 3 to the substrate 4 material. The acrylic-based adhesive does not contain VOC's. In addition to the effectiveness of the adhesive bond of the copper and the substrate, the tape adhesive methodology also provided the advantage of ease of application and significant material cost advantages. Due to heating and cooling considerations encountered in the field the substrate thickness was also determined to influence the operation of the copper grid.

The allowable substrate 4 thickness range is 0.185 inches to 0.687 inches (FIG. 5). If the substrate thickness is less than 0.185, inches the material is too flexible and results in work hardening distortion of the copper tines and ultimate material failure. If the substrate thickness is greater than 0.687 inches the differential expansion of the substrate results in the formation of minute tears in the adhesive material which allows water to enter the tear space between the tine and the substrate and cause ultimate adhesive failure. Also, since both the copper grid and the substrate surfaces are smooth it was determined that by using a 120 grit emery cloth to scratch both surfaces prior to joining the pieces enhances the adhesion zone properties.

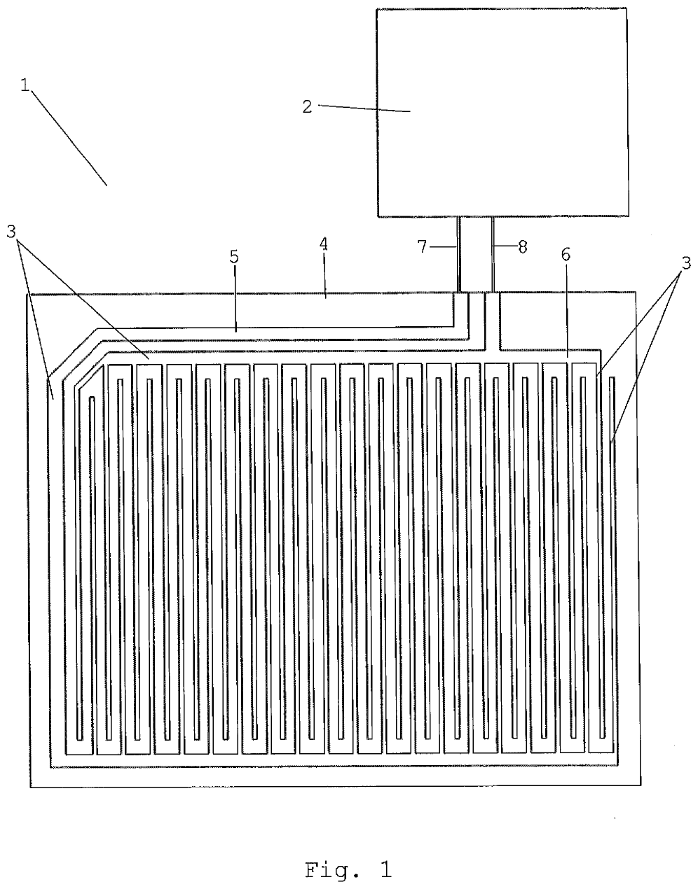

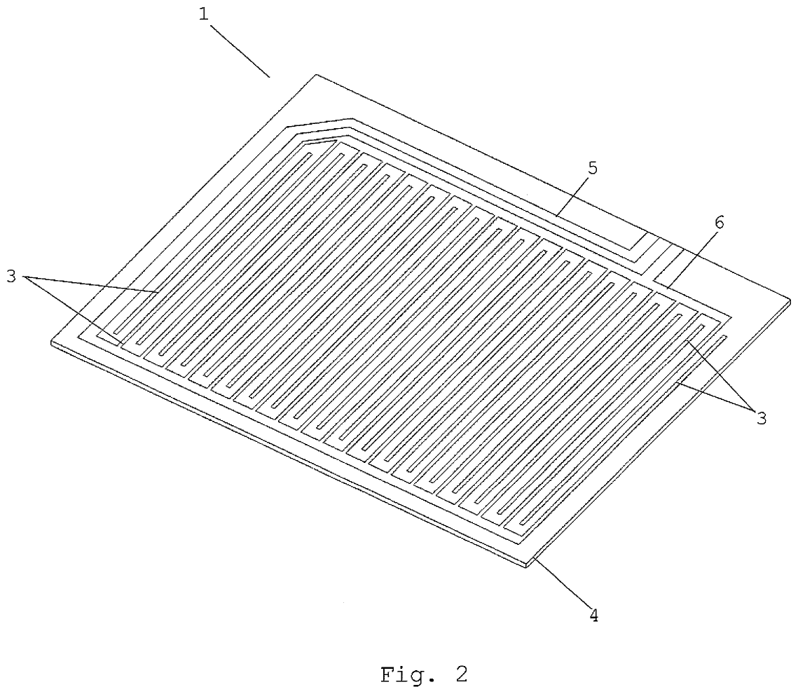

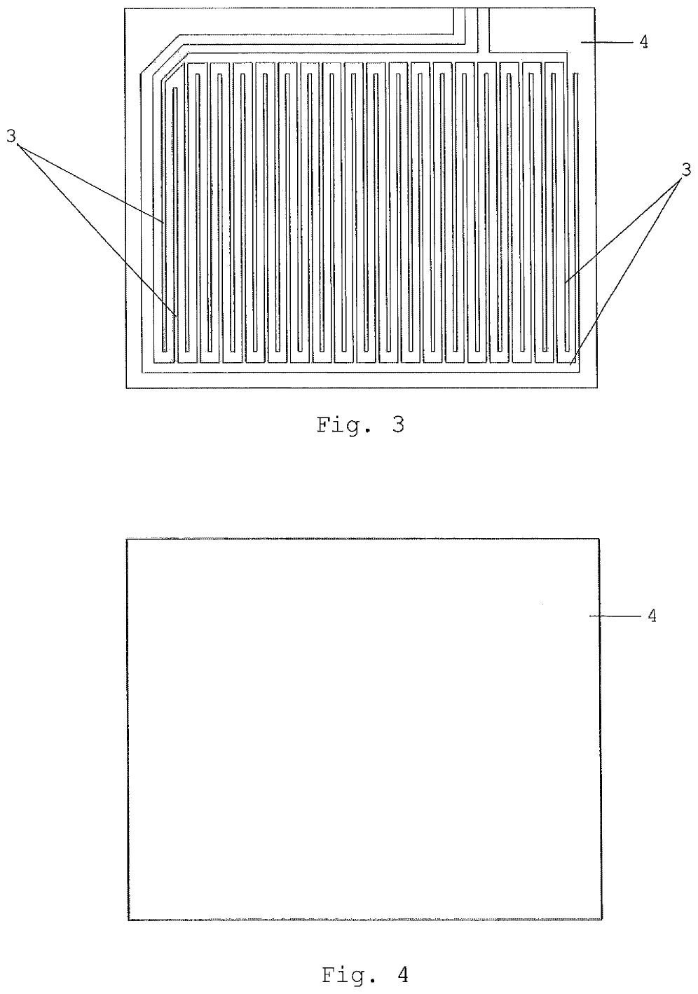

As depicted in FIGS. 1-3, the copper tines 3 can be subdivided into a first set 5 of tines and a second set 6 of tines. The first set 5 is configured on the substrate 4 such that no portion of the first set 5 of tines contacts any portion of the second set 6 of tines. Further, the voltage source 2 includes a positive terminal 7 and a negative terminal 8. In operation, the first set 5 of tines must be connected to one terminal while the second set 6 of tines must be connected to the other terminal such that circuit is completed when something, such as an insect, connects any point of the first set 5 of tines and any point of the second set 6 of tines. The figures depict the first set 5 of tines connected to the positive terminal 7 and the second set 6 of tines attached to the negative terminal 8, but the connections can be reversed as long as each set is attached to a different terminal.

What is claimed is:

1. An electric grid comprising:
A voltage source having a positive terminal and a negative terminal, a rigid substrate, a first set of copper tines affixed to said rigid substrate, and a second set of copper tines affixed to said rigid substrate.

2. The electric grid of claim 1 where the copper tines are between 0.003 inches to 0.330 inches thick.

3. The electric grid of claim 1 where the copper tines of the first set of copper tines are spaced inches to 0.620 inches apart from the copper tines of the second set of copper tines

4. The electric grid of claim 1 where the copper tines are produced by photochemical etching.

5. The electric grid of claim 2 where the copper tines are produced by photochemical etching.

6. The electric grid of claim 3 where the copper tines are produced by photochemical etching.

7. The electric grid of claim 1 where the substrate is acrylic.

8. The electric grid of claim 2 where the substrate is acrylic.

9. The electric grid of claim 3 where the substrate is acrylic.

10. The electric grid of claim 1 where the substrate is glass.

11. The electric grid of claim 2 where the substrate is glass.

12. The electric grid of claim 3 where the substrate is glass.
